(19) United States
(12) Patent Application Publication
(10) Pub. No.: US 2006/0039050 A1
(43) Pub. Date: Feb. 23, 2006

(54) Live print scanner with active holographic platen

(76) Inventors: John F. Carver, Palm City, FL (US); Gregory Cannon, Boynton Beach, FL (US); George W. McClurg, Jensen Beach, FL (US)

Correspondence Address: STERNE, KESSLER, GOLDSTEIN & FOX PLLC, 1100 NEW YORK AVENUE, N.W., WASHINGTON, DC, 20005, US

(21) Appl. No.: 11/209,048

(22) Filed: Aug. 23, 2005

Related U.S. Application Data
(60) Provisional application No. 60/603,282, filed on Aug. 23, 2004.

(51) Int. Cl. G03H 1/22

(52) U.S. Cl. 359/32; 359/15

(57) ABSTRACT

This invention relates to the use of holographic optical elements in the design and application of biometric scanning instruments used typically for capturing biometric information such as fingerprints and handprints. Applications of holographic optical elements include providing several novel operational features involving display, annunciation, and control of biometric fingerprint and handprint scanning instruments. The holographic elements may be used to create an active platen. The active platen may be illuminated to project graphical displays on the platen such as time stamps, instructions to users, or feedback on print quality.

### CROSS-REFERENCE TO RELATED APPLICATIONS

This application claims benefit to U.S. Provisional Pat. Appl. No. 60/603,282, filed Aug. 23, 2004, the disclosure of which is hereby incorporated by reference herein in its entirety.

### BRIEF SUMMARY OF THE INVENTION

This invention relates to the use of holographic optical elements in the design and application of biometric scanning instruments used typically for capturing biometric information such as fingerprints and handprints to provide enhanced operational features. Holographic optical elements may be used in place of conventional fingerprint scanning elements, such as platens and prisms, to provide the opportunity for fingerprint scanning manufacturers to reduce product development cycle times, reduce product cost, size, and weight, and provide optical design flexibility not afforded by common glass and plastic refractive optical elements.

The holographic elements may be used to create an active platen. The active platen may be illuminated to project graphical displays on the platen such as time stamps, instructions to users, or feedback on print quality.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1A shows a holographic platen that indicates an active platen area for fingerprint capture according to an embodiment of the present invention.

FIG. 1B shows a holographic platen that indicates an active platen area for handprint capture according to an embodiment of the present invention.

FIGS. 2A-2C show a holographic platen providing three respective print quality feedback indications according to an embodiment of the present invention.

FIG. 3A shows a holographic platen having a virtual slider that provides an indication in real-time relating to a print capture according to an embodiment of the present invention.

FIG. 3B shows a holographic platen having virtual buttons or keys that can be displayed and monitored for user interactions according to an embodiment of the present invention.

FIG. 4A shows a holographic platen with images or text displayed near an active area of the holographic platen according to an embodiment of the present invention.

FIG. 4B shows a holographic platen with images or text displayed within an active area of the holographic platen according to an embodiment of the present invention.

FIG. 5 shows a holographic platen with an animated image area according to an embodiment of the present invention.

FIG. 6 is an illustration of a system for capturing a fingerprint image according to an embodiment of the present invention.

The present invention will be described with reference to the accompanying drawings. The drawing in which an element first appears is typically indicated by the leftmost digit(s) in the corresponding reference number.

### DETAILED DESCRIPTION OF THE INVENTION

Holography is a method of producing an image by means of optical wave-front reconstruction. In this method, a holographic element is used to reconstruct in detail the wave field emitted by the object to be imaged. To make a holographic image, two optical beams may be used, one of which illuminates the object to be imaged. The other beam, often called a reference beam, is reflected onto an image-capturing screen or plate. Often, the output from a coherent light source (such as a laser) is separated into two beams for the illumination and reference beam purposes. Alternatively, the reference beam may be used to illuminate the object.

The image-capturing screen, or detector, is exposed simultaneously to the reference beam and the reflected light from the object. The resulting interference pattern recorded by the detector constitutes the reconstructed image, called the hologram. A hologram is a special ‘photograph’ of an object that retains information about the phase of waves coming from the actual object. The hologram is illuminated with a monochromatic optical beam (usually a laser beam). Part of the resulting diffracted wave field is a precise, three-dimensional copy of the original wave reflected by the object.

Holographic material is used in biometric scanners, such as live print scanners, to capture biometric data and to provide additional operational features. Embodiments of the present invention describes multiple applications of holographic optical elements for providing several novel operational features including, but not limited to, display, annunciation and control of biometric fingerprint and handprint scanning instruments. These operational features with holographic material can also be utilized in other types of instruments where control, display or operator inputs are required.

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

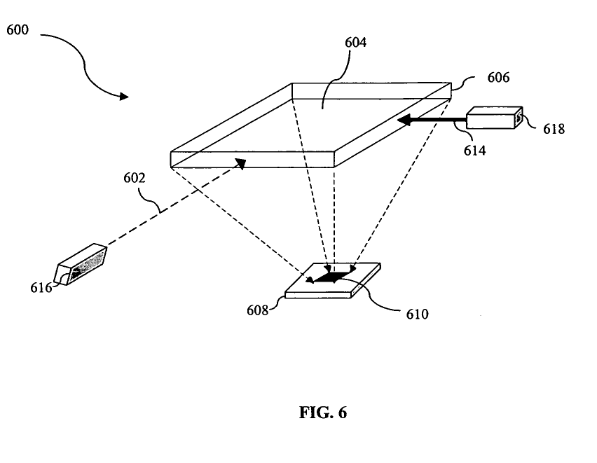

FIG. 6 is an illustration of a system 600 for capturing a holographic image of a print pattern, such as a fingerprint, through holographic material 606. Holographic material 606 may include any type of holographic material or element including, but not limited to, one or more holographic optical elements (HOEs), holographic diffraction grating(s), holographic filter(s), holographic diffractive optic(s), or combinations thereof. An example HOE may include, but is not limited to, a volume holographic optical element.

Holographic material 606 may be configured to act as one or more optical components, such as a lens and/or mirror, at various angles of input light. In this way, holographic material 606 can shape and direct incident reference beams to capture desired images including print images as described herein. When holographic material 606 is illuminated by reference beam 602, a high contrast fingerprint image may be obtained. Reference beam 602 may be produced by, for example, source 616. Typically, the fingerprint image will be due to frustrated total internal reflection (“TIR”) caused by reference beam 602 at the platen surface 604 of the holographic material 606 in the presence of fingerprint ridges or valleys.

In a bright-field illumination embodiment, when a finger, for example, is placed in contact with platen surface 604, the TIR within holographic material 606 is broken by ridges of the finger. Thus, light from reference beam 602 will reflect from areas of platen surface 604 under valleys of the finger, while light absorbed by ridges of the finger will not be reflected. The contrast between the ridges and valleys of the finger form an image 610 that can be viewed by a detector, such as detector 608. In this embodiment, ridges may appear relatively dark while valleys and background areas may appear relatively bright in the captured print image. Further, holographic material 606 can optionally act to focus image 610 onto a detector 608. Additional optical elements or optical systems (not shown) can also be added as a further option if additional beam shaping, focusing, magnifying, or directing of image 610 onto detector 608 is desired.

Alternatively, in a dark-field illumination embodiment light from holographic material 606 on platen 604 may not be directly imaged by detector 608. In a dark-field illumination embodiment, the finger is directly illuminated, and light entering the print ridges is diffused and reflected back into holographic material 606 in the areas where the print ridges contact platen surface 604 and break TIR. The light reflected from the ridges is focused at image 610, thereby producing a representative print image. The valleys and background areas may appear relatively dark while ridges may appear relatively bright in the captured print image. Like the bright-field arrangement, holographic material 606 can optionally act to focus image 610 onto detector 608 to capture image 610 in a dark-field arrangement.

Additional optical elements or optical systems (not shown) can also be added as a further option if additional beam shaping, focusing, magnifying, or directing of image 610 onto detector 608 is desired.

Reference beam 602 causes holographic platen 606 to transmit image 610 to detector 608. Other reference beams, such as reference beam 614 from source 618, may illuminate holographic material 606 to provide holographic material 606 with additional features.

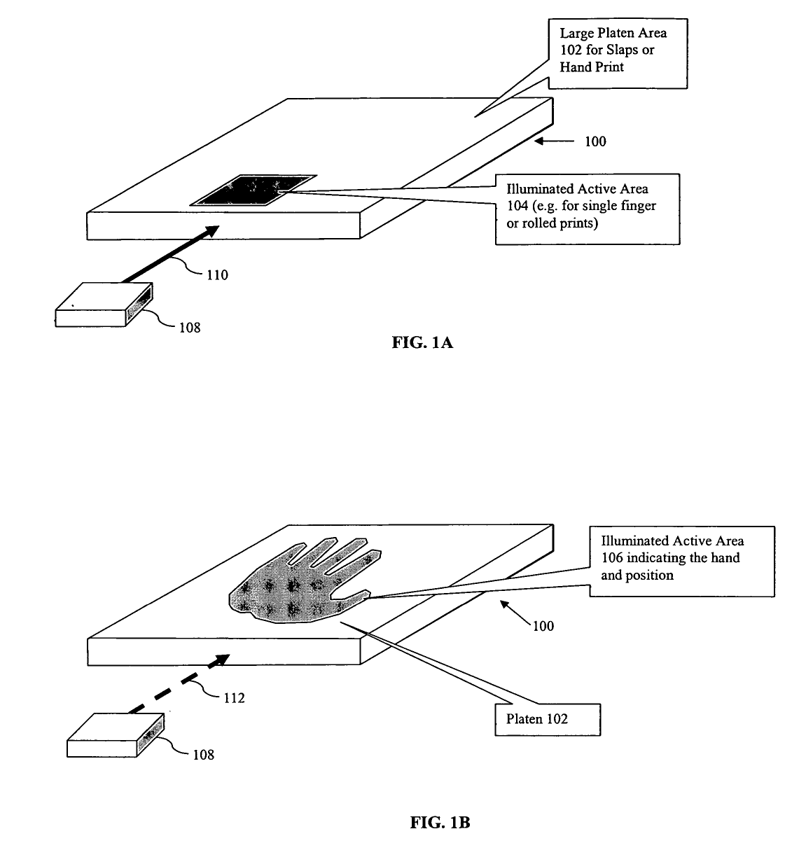

Certain areas of a holographic platen in a live print scanner can be specially illuminated to actively display a user guide on the holographic platen. For example, the user guide may indicate where a user is to place his or her finger or hand. FIGS. 1A and 1B show holographic material 100 having a large holographic platen area 102 capable of receiving one or more fingers or hands of a user. Active areas of holographic platen area 102 may be controlled by reference beams produced by beam source 108. In FIG. 1A, an active area 104 is displayed within the platen area 102, which is controlled by reference beam 110. Active area 104 provides a visual indication to a user on where to place his or her finger during a live scan. This can help ensure that a user places the proper finger in an optimum location for live print capture. A user can simply see the active area 104 and place his or her finger(s) on area 104. In one example shown in FIG. 1A, active area 104 is displayed as a rectangular or square shape located in an approximately center, bottom region of platen area 102. In certain applications, active area 104 may be especially helpful to guide a user to place his or her finger in the capture of a single fingerprint (flat or roll print), or a four-finger slap print.

Similarly, as shown in FIG. 1B, an active area 106 is displayed as a hand shape located in an approximately center region of platen area 102. Active area 106 may be controlled by, for example, reference beam 112. In certain applications, active area 106 may be especially helpful to guide a user to place his or her correct hand (right or left) in the capture of a hand or palm print. Active areas 104 and 106 as shown in FIGS. 1A-1B are illustrative and not intended to limit the present invention. Active areas 104 and 106 can be illuminated to have different shapes and can be located in different locations within platen area 102 depending upon a particular application and type of print desired to be captured.

Beam source 108 may be controlled by a controller (not shown). In one embodiment, beam source 108 may produce a single illumination beam to illuminate holographic material 100. In another embodiment, beam source 108 may be an array of discrete illumination elements which turn on or off in response to the controller, and which can be used to dynamically change text or graphics on holographic material 100. In yet another embodiment, beam source 108 may be configured to produce an illumination beam which causes holographic material 100 to display predetermined text or graphics, the activation of which is controlled by the controller. In still another embodiment, beam source 108 may pass through an aperture, such as a filter, LCD, or the like, which contains a pattern to be displayed on holographic material 100.

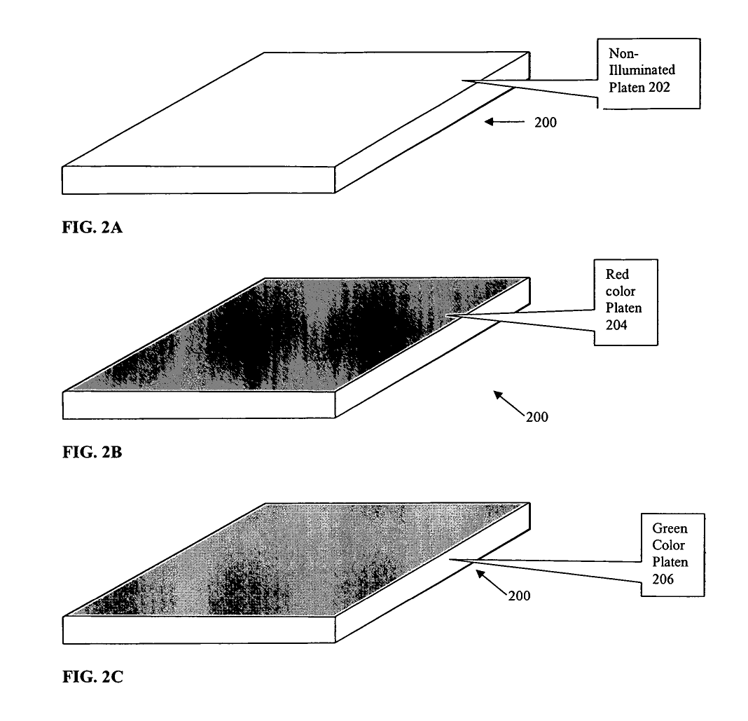

According to a further embodiment, certain areas of a holographic platen in a live print scanner can be specially illuminated to provide a quality feedback indication to a user in a live scan. For instance, such a quality feedback indication can indicate whether a captured print is of acceptable or not acceptable quality. In an example shown in FIGS. 2A-2C a platen surface 202 of holographic material 200 may provide three respective print quality feedback indications. In FIG. 2A, platen surface 202 of holographic material 200 is not illuminated, which indicates that no finger or hand has been placed on platen surface 202. In FIG. 2B, platen surface 202 is illuminated in a first color (such as red) to produce a first color platen 204. First color platen 204 indicates that a print captured in a live scan is of an unacceptable quality. In FIG. 2C, platen surface 202 is illuminated in a second color (such as green) to produce a second color platen 206. Second color platen 206 indicates that a print captured in a live scan is of an acceptable quality. Any print quality test can be used including, but not limited to, a ridge count test and/or image quality test. First and second color platens 204 and 206 are illustrative and not intended to limit the present invention as other colors, shapes, patterns, and/or indicia can be illuminated to provide an indication of quality.

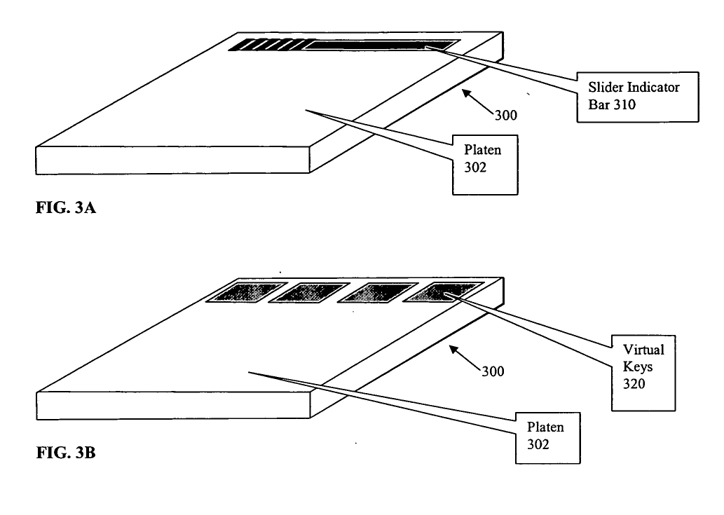

According to further embodiments, certain areas of a holographic platen in a live print scanner can be specially illuminated to provide control or other information to a user in a live scan. In one example, FIG. 3A shows holographic material 300 having a platen surface 302 and an area 310. During a live print scan, area 310 is illuminated to display a virtual slider. For example, during a roll print a user rolls his or her finger from one side of a finger to the other on platen 302. The virtual slider is illuminated to provide real time control information to a user by changing its length to indicate a parameter, such as, rolled finger position or finger roll speed. The length of the slider can change to track where a finger is during its roll based on a detection of the finger's position. Alternatively, the length of the slider can change in a predetermined fashion to serve as a guide that a user can follow so that a user rolls his or her finger at an acceptable speed.

In another example, FIG. 3B shows holographic material 300 having a platen surface 302 and an area 320. During a live print scan, area 320 is illuminated to display one or more virtual keys or buttons. The keys or buttons can have text, graphics, icons, colors or other information displayed therein. These keys or buttons can then be monitored for user interaction.

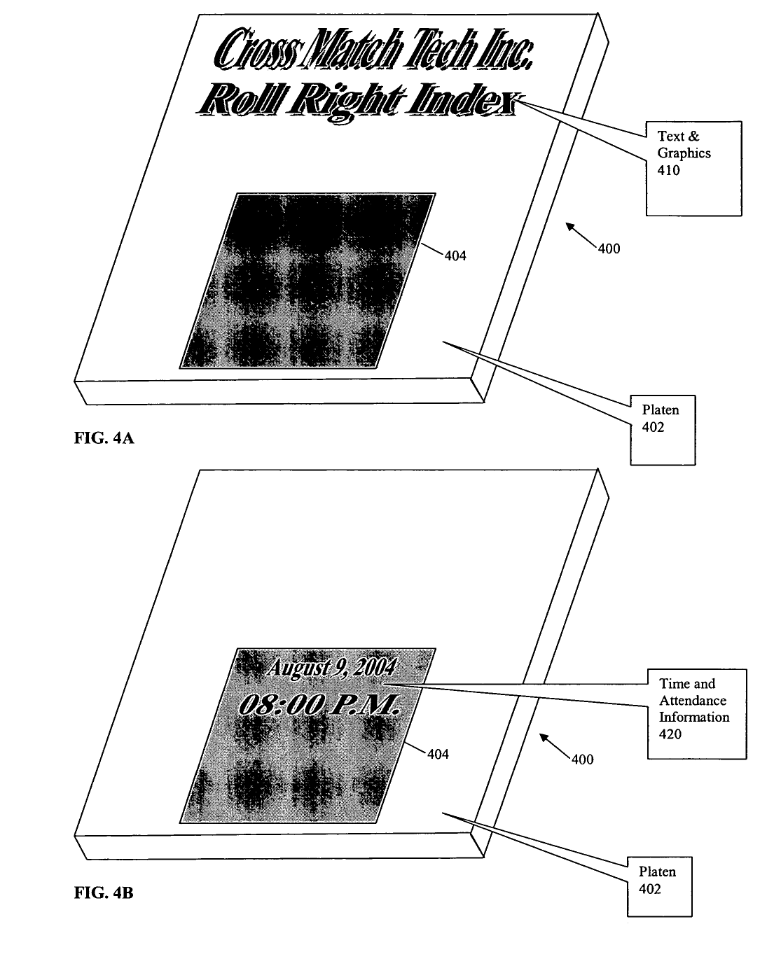

FIG. 4A shows holographic material 400 having a platen surface 402 that includes an area 410 with images or text displayed near an active platen area 404 according to an embodiment of the present invention. In one example, the text and/or images can provide instructions to a user to facilitate a live scan capture. For instance, the text can indicate which finger or hand a user is to place and what type of print (e.g., roll or flat print or slap) is to be captured. This example is illustrative and not intended to limit the present invention as other types of instructions or messages can be illuminated in area 410 on holographic platen surface 402.

FIG. 4B shows holographic material 400 having a platen surface 402 that includes images or text illuminated within active platen area 404 according to a further embodiment of the present invention. In one example, date and time information 420 can be displayed. Such date and time information can be helpful in access control, time and attendance, and other applications using live print scanners.

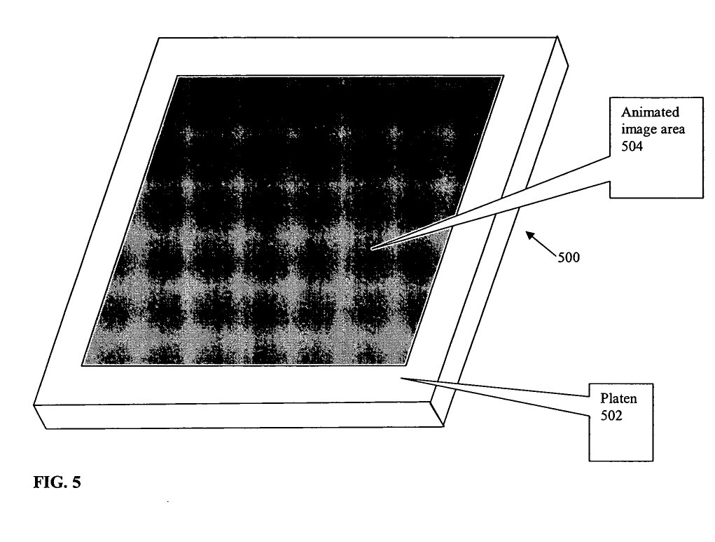

FIG. 5 shows holographic material 500 with a platen surface 502 that includes an area 504 illuminated with animation according to an embodiment of the present invention. Such animation can include, but is not limited to, one or more predetermined animated holographic images.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method of capturing a print image using a holographic platen, comprising:
displaying a user guide on the holographic platen;
illuminating an object having a print pattern;
producing a holographic image of the print pattern; and
detecting the holographic image of the print pattern.

2. The method of claim 1, wherein the displaying step comprises indicating a position in which the object is to be placed.

3. The method of claim 1, wherein the displaying step comprises:
illuminating the holographic platen in a first color when a captured print image is of an unacceptable quality; and
illuminating the holographic platen in a second color when a captured print image is of an acceptable quality.

4. The method of claim 1, wherein the displaying step comprises displaying a sliding indicator for guidance during a roll print.

5. The method of claim 1, wherein the displaying step comprises displaying at least one virtual button.

6. The method of claim 1, wherein the displaying step comprises displaying textual instructions to a user.

7. The method of claim 1, wherein the displaying step comprises displaying date and time information related to the print image.

8. The method of claim 1, wherein the displaying step comprises displaying animated holographic images.

9. A system for producing a holographic image of a print pattern, comprising:
a holographic platen configured to produce an image of the print pattern;
a controller configured to cause an illumination source to illuminate the holographic platen with a reference beam, wherein the reference beam causes the holographic platen to display a user guide on the holographic platen; and
a detector configured to detect the holographic image of the print pattern.

10. The system of claim 9, wherein the controller is further configured to cause the holographic platen to display the user guide as an indicator for positioning the object on the holographic platen.

11. The system of claim 9, wherein the controller is further configured to cause the holographic platen to provide a feedback indicator regarding a captured print image.

12. The system of claim 11, wherein the feedback indicator turns the holographic platen a first color when the captured print image is of an unacceptable quality, and wherein the feedback indicator turns the holographic platen a second color when the captured print image is of an acceptable quality.

13. The system of claim 9, wherein the controller is further configured to cause the holographic platen to display the user guide as a sliding indicator for guidance during a roll print.

14. The system of claim 9, wherein the controller is further configured to cause the holographic platen to display the user guide as at least one virtual button.

15. The system of claim 9, wherein the controller is further configured to cause the holographic platen to display the user guide as textual instructions to a user.

16. The system of claim 9, wherein the controller is further configured to cause the holographic platen to display the user guide in a series of animated holographic images.

17. A live print scanning system, comprising:
a holographic platen having at least one active area;
a controller configured to cause an illumination source to illuminate the holographic platen with a reference beam, wherein the reference beam causes the holographic platen to display a user guide in the active area; and
a detector configured to detect an image of an object placed on the holographic platen.

18. The system of claim 17, further comprising:
an illumination system for illuminating the object placed on the holographic platen.

19. The system of claim 17, wherein the user guide indicates proper placement for the object on the holographic platen.

20. The system of claim 17, wherein the user guide is a feedback indicator indicative of captured print image quality.
